(19) United States
(12) Patent Application Publication
(10) Pub. No.: US 2007/0163177 A1
(43) Pub. Date: Jul. 19, 2007

(54) Door module for a vehicle door, vehicle door comprising a door module as well as method of mounting a door module to a vehicle door

(76) Inventors: Thomas Heyer, Sassenburg (DE); Jean-Francois Bigourden, Neudorf-Platendorf (DE)

Correspondence Address: CARLSON, GASKEY & OLDS, P.C., 400 WEST MAPLE ROAD, SUITE 350, BIRMINGHAM, MI, 48009, US

(21) Appl. No.: 11/653,783

(22) Filed: Jan. 16, 2007

(30) Foreign Application Priority Data
Jan. 18, 2006 (DE) 10 2006 002 406.0

(51) Int. Cl. E05F 11/38

(52) U.S. Cl. 49/348

(57) ABSTRACT

The invention relates to a door module for a vehicle door that includes a module plate and a window lifter rail attached to the module plate. The window lifter rail is movable in translation, is pivotally attached to the module plate, and is fixed by an easily detachable retaining mechanism in a supply position. The invention further relates to a vehicle door comprising such a door module as well as to a method of mounting a door module to a vehicle door.

### RELATED APPLICATIONS

The application claims priority to German Application No. 10 2006 002 406.0, which was filed on Jan. 18, 2006.

### BACKGROUND OF THE INVENTION

The invention relates to a door module for a vehicle door as well as to a vehicle door comprising such a door module. The invention further relates to a method of mounting a door module to a vehicle door.

Modern vehicle doors typically are equipped with numerous functional components, for instance a window lifter system with at least one window lifter rail, a door lock, loudspeaker, etc. For the purpose of saving time, these functional components are not individually mounted to an inner side of the vehicle door, but are pre-assembled on a plate to provide a door module. The pre-assembled door module is subsequently fastened to the inner wall of the vehicle door. It is preferred that a module plate of the door module completely closes an opening in the inner wall of the vehicle door, which serves to accommodate the functional components, in order to ensure an effective separation between wet and dry sides of the vehicle door. To this end, the module plate essentially has the same dimensions as the opening, with a small overlap required for installation-related reasons.

Due to stability reasons, it is desirable that the window lifter rail in an installed state engage behind an edge of the inner wall with at least one end, better yet with both ends, which means that it protrudes beyond an upper or lower edge of the module plate. The opening in the inner wall should be selected to be as small as possible for stiffness of the vehicle door. Because the length of the window lifter rails is greater than a height of the opening, it is possible to achieve with an unchanged small opening a larger pane travel as compared with conventional window lifters. The mounting of the door module to the vehicle door, however, is aggravated.

Therefore it is the object of the invention to simplify the mounting of a door module to a vehicle door.

### SUMMARY OF THE INVENTION

According to a first aspect of the invention, a door module for a vehicle door is provided for this purpose. The door module comprises a module plate and a window lifter rail attached to the module plate. The window lifter rail is movable in translation, is pivotally attached to the module plate, and is fixed by an easily detachable retaining mechanism in a supply position. Due to the fact that the window lifter rail is both movable in translation and pivotally supported on the module plate, the window lifter rail can be immobilized, in particular, in a supply position in which only one end of the window lifter rail protrudes beyond an edge of the module plate. This allows a comparably simple insertion of the window lifter rail into an opening of the vehicle door, with the retaining mechanism making sure that the window lifter rail does not perform any undesired movement in the meantime.

Preferably, the easily detachable retaining mechanism is a cable retainer that engages the window lifter rail, and engages a protrusion or an opening of the module plate. As a mass-produced article, such a cable retainer represents a particularly low-cost and yet effective retaining mechanism. When the cable retainer engages an opening of the module plate, there is the further advantage that the cable retainer can also be removed from a dry area side of the module plate, i.e. a side facing away from the window lifter rail. Consequently, the cable retainer can be detached without any problems after the module plate has been put onto the opening in the vehicle door, and closes this opening at least to a large extent.

Alternatively, the easily detachable retaining mechanism may be a clip that is firmly attached to the module plate and engages the window lifter rail. The clip may be configured such that the window lifter rail will be disengaged from the clip by a swiveling motion, for example. Forming the clip in one piece with the module plate is also possible. Alternatively, the clip can have merely a loose connection with the module plate by the clip engaging a protrusion or an opening of the module plate.

In one example, the window lifter rail comprises a firmly attached fastening bolt at one end. In the functional position of the window lifter rail, this bolt may engage a counter piece attached to an inner wall of the vehicle door, thereby immobilizing the window lifter rail.

According to a further embodiment, the window lifter rail comprises a firmly attached fastening bolt at both ends, which serves for the immobilization on the vehicle door.

The above described, movable and pivotable supporting of the window lifter rail on the module plate can be achieved in a particularly simple way. In one example, the window lifter rail has an elongated hole that is engaged by a stud attached to the module plate. With a module plate made of plastic, the stud is integrally formed with the module plate. It would also be possible, of course, that the module plate has the elongated hole which is engaged by a bolt connected with the window lifter rail, with the former variant presenting advantages in respect of the separation of wet and dry area sides.

The problem of the invention is also solved by a vehicle door comprising a door module. The vehicle door includes an inner wall provided with an opening that has an upper and a lower edge, an opening for a fastening bolt of a window lifter rail being provided on one of these edges, and a unilaterally opened slit for a fastening bolt of the window lifter rail being provided at the other edge. The window lifter rail is fastened to the inner wall by two fastening bolts in a region of the upper and lower edges. With this design, only one of the fastening bolts will be put through the associated opening in the inner wall of the vehicle door, while the other fastening bolt is laterally inserted in the unilaterally opened slit in a simple and time-saving manner. This results in a particularly simple fastening mechanism for the door module.

It is preferred that the fastening bolt is firmly attached to the window lifter rail. After that, the fastening bolt will be immobilized on the vehicle door by an associated nut.

According to the preferred embodiment, the slit is formed in a fastening lug fastened to the inner wall near the upper or lower edge. In order to facilitate the insertion of the fastening bolt and yet serve for a reliable mounting, the slit should taper starting from an open end.

A door lock can be attached to the door module, where the door lock is screwed to the vehicle door. As already initially mentioned, this door lock is pre-assembled on the door module and likewise screwed to the vehicle door over the course of mounting the door module.

In particular, the door module is formed in the manner which has already been described.

According to a third aspect of the invention, there is further provided a method of mounting a door module to a vehicle door, with the door module comprising a module plate and at least one window lifter rail. The window lifter rail is attached to the module plate to be at least pivotable, and is fixed to the module plate by a retaining mechanism in a supply position that is swiveled compared to a functional position. The method comprises the following described steps. A first end of the window lifter rail is immobilized by a first fastening element on an inner wall of the vehicle door in a region of an upper or lower edge of an opening provided in the inner wall. The retaining mechanism is detached, and after that, the module plate is laterally shifted to a final position, whereby the window lifter rail is swiveled into a functional position. Finally, the second end of the window lifter rail is immobilized by a second fastening element on the inner wall in a region of an opposite edge of the opening. Thus, in the method according to the invention, the window lifter rail is transferred from a swiveled supply position to an essentially vertical functional position by arresting one end of the window lifter rail, and subsequently laterally shifting the entire module plate. Thus, the swiveling of the window lifter rail is performed in an uncomplicated way, without the need of a direct contact on the window lifter rail, which is completely covered by the module plate. This is why an access opening in the module plate for a tool that swivels the window lifter rail is also not required.

According to a preferred embodiment, the immobilizing of the second end of the window lifter rail is carried out by laterally shifting the module plate. This is accomplished by the second fastening element, which is attached to the window lifter rail, laterally engaging a counter piece attached to the inner wall of the vehicle door. Thus, the second end of the window lifter rail will be automatically immobilized, further simplifying the installation process.

The fastening elements are bolts with associated nuts, which will not be fully tightened until the second end of the window lifter rail is immobilized. This provides sufficient clearance for shifting the module plate.

A door lock may be pre-fixed to the module plate, where the door lock attains a functional position by laterally shifting the module plate, in which position the door lock will be finally fixed after immobilizing the second end of the window lifter rail. Thus, even the door lock can be installed in a simple way, while being concealed. The door lock can even engage behind an edge of the opening in the vehicle door because the module plate is put onto the opening to be laterally offset at first, before the module plate is shifted to a final position.

In order to ensure a sufficient stability, the module plate can be fixed in a final position after immobilizing the second end of the window lifter rail, for instance by screwing.

In particular, the method according to the invention uses a door module or a vehicle door of the type already described.

These and other features of the present invention can be best understood from the following specification and drawings, the following of which is a brief description.

### BRIEF DESCRIPTION OF THE DRAWINGS

FIG. 1 is a top view of a wet area side of a door module for a vehicle door according to a first embodiment of the invention.

FIG. 2 is a top view of a dry area side of a door module according to a second embodiment of the invention.

FIG. 3 is a perspective sectional view of an enlarged detail of the door module of FIG. 1.

FIG. 4 is a top view of the dry area side of a vehicle door as well as of the door module of FIG. 2 in a state prior to installation.

FIG. 5 is a top view of the dry area side of the vehicle door and of the door module of FIG. 4 after positioning a first fastening element.

FIG. 6 is a top view of the dry area side of the vehicle door and of the door module of FIG. 4 after immobilizing the lower end of the window lifter rail.

FIG. 7 is a top view of the dry area side of the vehicle door and of the door module of FIG. 4, showing detachment of the retaining mechanism.

FIG. 8 is a top view of the dry area side of the vehicle door and of the door module of FIG. 4, showing a lateral shifting of the module plate.

FIG. 9 is a perspective view of an enlarged detail of the wet area side of the vehicle door of FIG. 4.

FIG. 10 is a top view of the dry area side of the vehicle door of FIG. 4 after immobilizing the second end of the window lifter rail.

### DETAILED DESCRIPTION OF THE PREFERRED EMBODIMENT

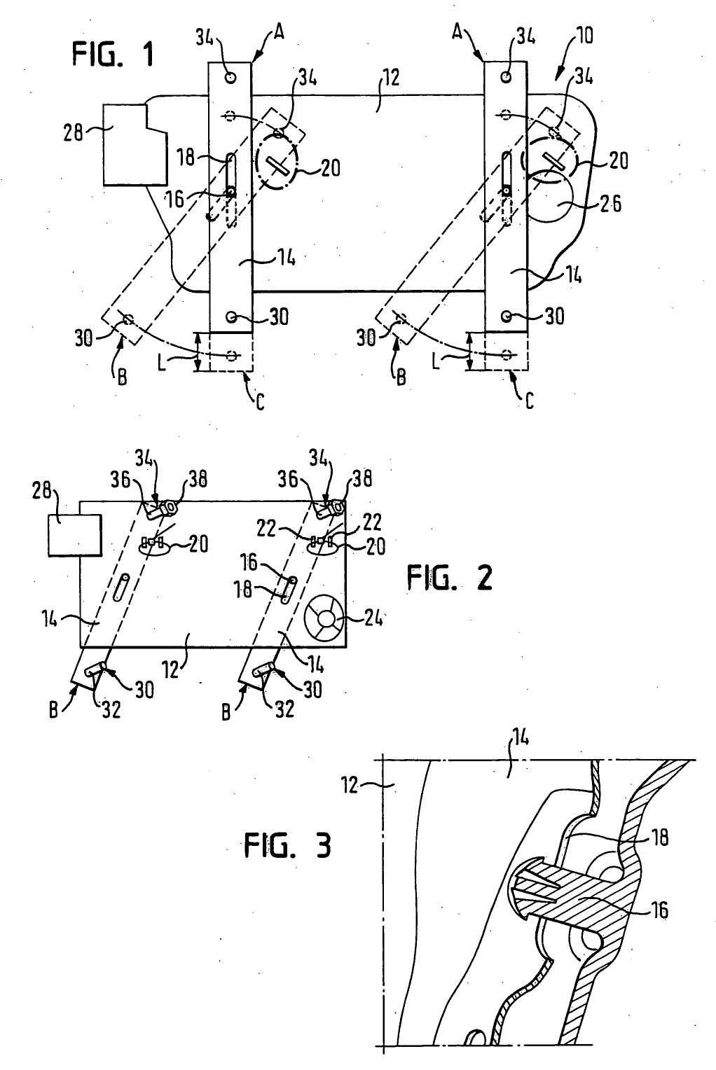

FIG. 1 shows a door module 10 that is to be mounted to a vehicle door. The door module 10 has a module plate 12 and two window lifter rails 14, which are shown in FIG. 1 both in a vertical functional position A (solid lines) and in a supply position B (broken lines) swiveled with respect to the functional position. To attach the window lifter rails 14, the module plate 12 is provided with one stud 16 for each window lifter rail 14. The studs 16 are integrally connected with the module plate 12 and engage an elongated hole 18 of a respective window lifter rail 14 (see also FIG. 3). In this way, both window lifter rails 14 are movable in translation and are pivotally connected with the module plate 12.

Next to the functional position A and the supply position B, there is further indicated in FIG. 1 a (theoretical) intermediate position C. In this position, the window lifter rails 14 extend in a vertical direction, but are shifted downward compared with the functional position A by a length L essentially corresponding to a length of the elongated hole 18. Starting from the supply position B, the intermediate position C is reached purely by swiveling the window lifter rails 14; the transfer to the functional position A is done by a longitudinal displacement by the length L. While in the intermediate position, the stud 16 is arranged on an upper end of the elongated hole 18. In the functional position A, the stud 16 is arranged essentially at a lower end of the elongated hole 18. It is to be noted that only the lower ends of the window lifter rails 14 protrude beyond an edge of the module plate 12 in the supply position B.

The window lifter rails 14 are each held in the supply position B by an associated one easily detachable retaining mechanism 20, which is in the form of a cable retainer. The cable retainer engages the window lifter rail 14 and further is put through two openings 22 in the module plate 12 (see FIG. 2). A particularly simple fastening of the window lifter rail 14 on the module plate 12 is provided by the window lifter rail 14 making a clip connection with the stud 16 via the elongated hole 18.

The retaining mechanism 20 may alternatively be a clip engaging the window lifter rail 14, which is either firmly attached to the module plate 12, or engages a protrusion or an opening in the module plate.

The door module 10 further has a loudspeaker 24, which in the embodiment shown in FIG. 2, is already inserted in an associated opening 26 of the module plate 12 (see FIG. 1). In addition, a door lock 28 is provided that is pre-fixed on the module plate 12. Of course, a door lock in this connection is also an element of a door lock that is connected with the door module 10, which together with an element—which is attached on the side of the vehicle door—forms a complete door lock.

Each window lifter rail 14 has a lower end provided with a first fastening element 30 that comprises a fastening bolt 32 firmly attached to the window lifter rail 14. The upper ends of the two window lifter rails 14 are each provided with a second fastening element 34 that likewise has a fastening bolt 36 firmly attached to the window lifter rail 14. An associated nut 38 is screwed on this fastening bolt 36 with a few revolutions. This can be seen in particular from FIG. 2, which shows the door module 10 generally from the dry area side, but the module plate 12 is illustrated transparent, so that components lying behind the module plate 12 are visible.

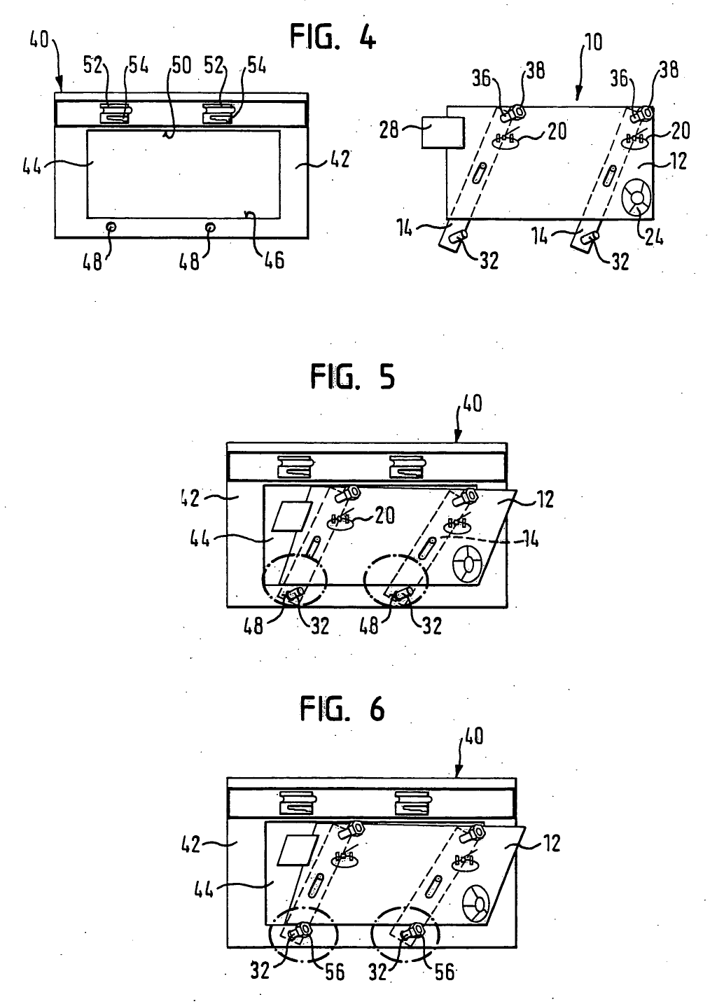

A method according to the invention of mounting the door module 10 to a vehicle door 40 will be described as follows on the basis of FIGS. 4 to 10. The vehicle door 40 has an inner wall 42 provided with a large-area opening 44. Two openings 48 for the fastening bolts 32 of the first fastening element 30 are provided in the inner wall 42 at a lower edge 46 of the opening 44. In a region of an upper edge 50 of the opening 44, there are two fastening lugs 52 fastened to the inner wall 42. In each of these fastening lugs 52, there is provided a unilaterally opened slit 54 for the fastening bolt 36 or the nut 38 connected therewith, attached to the upper end of the window lifter rails 14. It is also to be noted in FIG. 4 that the fastening lugs 52 are actually not visible viewed from the dry area side, because the fastening lugs 52 are arranged in a cavity formed in the vehicle door 40, and on the side of the inner wall 42 facing the cavity. For the sake of better clarity, the vehicle door 40 is illustrated in phantom in FIG. 4.

In the condition prior to installation, the window lifter rails 14 are fixed by the retaining mechanism 20 in a swiveled supply position on the module plate 12. Starting from the initial position shown in FIG. 4, the lower ends of window lifter rails 14 in the first instance are immobilized or arrested at the lower edge 46 of the inner wall 42 by the door module 10 with the window lifter rails 14, which project at the bottom, being inserted in the opening 44 such that the projecting ends of the window lifter rails 14 engage behind the lower edge of the inner wall 42 (FIG. 5). The fastening bolts 32 are put through the openings 48 from behind, and are preliminarily secured by nuts 56 that are arranged on the dry area side of the vehicle door 40 (FIG. 6). In this way a first end, in this case the lower end of each window lifter rail 14, is immobilized at the lower edge 46 of the vehicle door 40. After immobilizing the lower ends of the window lifter rails 14, the module plate 12 will be put against the vehicle door 40 also at an upper edge, by the module plate 12 being tilted about the horizontal (longitudinal direction of the vehicle).

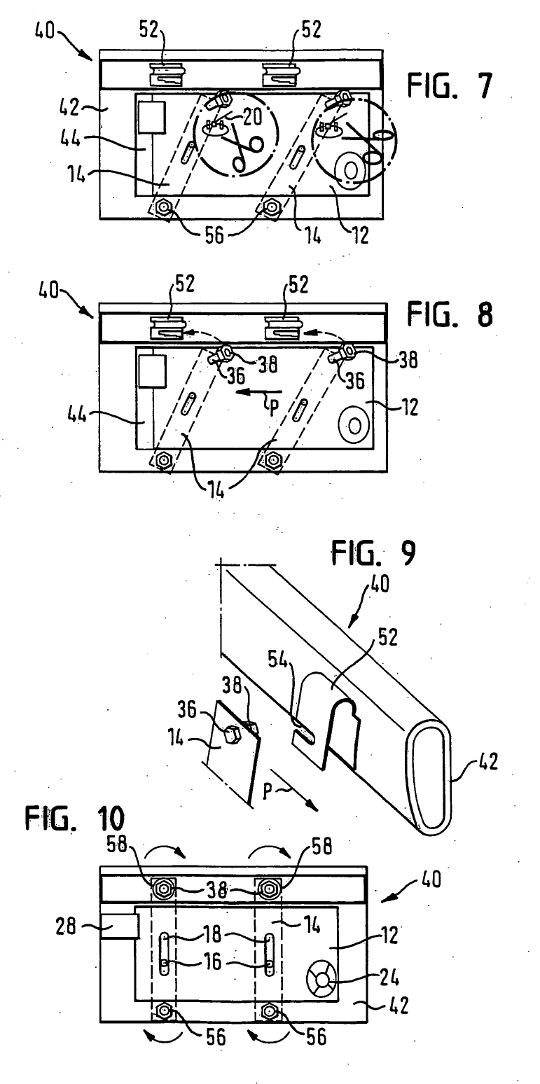

In the next method step, the retaining mechanism 20 is detached, by the cable retainer being removed with the embodiment shown in FIG. 7. It is due to the selected design, in which the cable retainers are passed through openings 22 of the module plate 12, that this method step can be performed from the dry area side.

The door module 10 is now in a position in which the door module 10 rests at the vehicle door 40 at the level of the opening 44, but is shifted to the right with respect to the opening 44. The window lifter rails 14 still are in their supply position B.

The final position of the module plate 12 is attained by the module plate 12 being laterally shifted, here to the left in the direction of arrow P (see FIG. 8). In doing so, the window lifter rails 14—which are no longer prefixed by the retaining mechanism 20—are automatically swiveled into a functional position A. As the lower ends of the window lifter rails 14 already are immobilized on the vehicle door 40, and the module plate 12 exclusively is shifted in the horizontal, there also occurs a translatory movement between the window lifter rails 14 and the module plate 12 in this process, which is made possible by the elongated hole 18. It is through the combined translatory and swiveling motion of the window lifter rails 14 that the fastening bolts 36, which are firmly connected with the upper end of the window lifter rails 14, enter the slits 54 in the fastening lugs 52 from the right side, with the associated nuts 38 coming to lie between the inner wall 42 of the vehicle door 40 and the protruding part of the fastening lug 52. This can be seen in particular from FIG. 9, showing the vehicle door 40 in the region of the upper edge 50 as seen from the wet area side.

Thus, the upper ends of the window lifter rails 14 are automatically immobilized by laterally shifting the module plate 12 on the inner wall 42 of the vehicle door 40. The fastening lug 52, including the laterally opened slit 54 formed therein, represents a counter piece for the fastening element 34, which is formed by the fastening bolt 36 and the associated nut 38.

When the module plate 12 is in a final position, and both ends of the window lifter rails 14 are immobilized on the vehicle door 40, the door lock 28—which likewise has reached a functional position by the laterally shifting of the module plate 12 will be finally fixed by being bolted with the vehicle door 40. Then, at first the nuts 56 of the lower fastening bolts 32 and subsequently the nuts 38 of the upper fastening bolts 36 are completely tightened. In order to allow the latter, openings 58 are provided at those spots of the inner wall 42 behind which the nuts 38 come to lie in the functional position of the window lifter rails 14. After having tightened the nuts 38, the openings 58 can be concealed by suitable covers. By tightening the nuts 38, 56, both ends of the window lifter rails 14 are firmly connected with the vehicle door 40 and are free of play. In the last step, the module plate 12 will be fixed in a final position, and is preferably screwed with the vehicle door 40 as well.

It is self-evident that the sequence in which the ends of the window lifter rails 14, the door lock 28, as well as the module plate 12, are finally fixed on the vehicle door 40, can be varied at will.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A door module for a vehicle door comprising:
a module plate; and
a window lifter rail attached to the module plate, the window lifter rail being movable in translation relative to the module plate, pivotally attached to the module plate, and fixed to the module plate by a detachable retaining mechanism in a supply position.

2. The door module according to claim 1, wherein the detachable retaining mechanism is a cable retainer that engages the window lifter rail and engages one of a protrusion and an opening of the module plate.

3. The door module according to claim 1, wherein the detachable retaining mechanism is a clip that is firmly attached to the module plate and engages the window lifter rail.

4. The door module according to claim 1, wherein the detachable retaining mechanism is a clip that is integrally formed with the module plate and engages the window lifter rail.

5. The door module according to claim 1, wherein the window lifter rail includes a firmly attached fastening bolt at one end.

6. The door module according to claim 1, wherein the window lifter rail includes a firmly attached fastening bolt at both ends.

7. The door module according to claim 1, wherein the window lifter rail includes an elongated hole which is engaged by a stud attached to the module plate.

8. The door module according to claim 1, wherein the window lifter rail includes an elongated hole which is engaged by a stud integrally formed with the module plate.

9. A vehicle door comprising:
a door module, the vehicle door including an inner wall provided with a first opening that has an upper and a lower edge, a second opening for a first fastening bolt of a window lifter rail being provided on one of the upper and lower edges, and a unilaterally opened slit for a second fastening bolt of the window lifter rail being provided at the other of the upper and lower edges, and wherein the window lifter rail is fastened to the inner wall by the first and second fastening bolts in a region of the upper and lower edges.

10. The vehicle door according to claim 9, wherein at least one of the first and second fastening bolts is firmly attached to the window lifter rail.

11. The vehicle door according to claim 9, wherein the unilaterally opened slit is formed in a fastening lug fastened to the inner wall near the other of the upper and lower edges.

12. The vehicle door according to claim 9, wherein a door lock is attached to the door module and where the door lock is screwed to the vehicle door.

13. The vehicle door according to claim 9, wherein the door module includes
a module plate, and
the window lifter rail attached to the module plate, the window lifter rail being movable in translation relative to the module plate, pivotally attached to the module plate, and fixed to the module plate by a detachable retaining mechanism in a supply position.

14. A method of mounting a door module to a vehicle door, the door module comprising a module plate and at least one window lifter rail that is attached to the module plate to be at least pivotable, and which is fixed to the module plate by a retaining mechanism in a supply position that is swiveled compared to a functional position,
the method comprising the following steps:
immobilizing a first end of the window lifter rail on an inner wall of the vehicle door in a region of one of an upper and lower edge of an opening provided in the inner wall with a first fastening element;
detaching the retaining mechanism;
laterally shifting the module plate into a final position, causing the window lifter rail to swivel into the functional position; and
immobilizing a second end of the window lifter rail on the inner wall in a region of the other of the upper and lower edge of the opening by a second fastening element.

15. The method according to claim 14, including immobilizing the second end of the window lifter rail by laterally shifting the module plate, with the second fastening element, which is attached to the window lifter rail, laterally engaging a counter piece attached to the inner wall of the vehicle door.

16. The method according to claim 14, wherein the first and second fastening elements are bolts with associated nuts that will be fully tightened only when the second end of the window lifter rail is immobilized.

17. The method according to claim 14, including pre-fixing a door lock to the module plate to attain a functional position by laterally shifting the module plate, in which position the module plate will be finally fixed after immobilizing the second end of the window lifter rail.

18. The method according to claim 14, including fixing the module plate in the final position after immobilizing the second end of the window lifter rail.

19. The method according to claim 14, including forming the door module to include the module plate and the window lifter rail, with the window lifter rail being movable in translation relative to the module plate, pivotally attached to the module plate, and fixed to the module plate by the retaining mechanism in the supply position.

20. The method according to claim 14, including forming the vehicle door to include a door module, the vehicle door including the inner wall provided with the opening that has the upper and lower edge, the inner wall including a second opening for the first fastening element of the window lifter rail that is provided on one of the upper and lower edges, and the inner wall including a unilaterally opened slit for the second fastening element of the window lifter rail that is provided at the other of the upper and lower edges, and wherein the window lifter rail is fastened to the inner wall by the first and second fastening elements in a region of the upper and lower edges.
